(19) United States
(12) Patent Application Publication
(10) Pub. No.: US 2002/0034966 A1
(43) Pub. Date: Mar. 21, 2002

(54) Wireless communications device

(76) Inventors: Yuichiro Saito, Chiba (JP); Yoshiki Kanayama, Saitama (JP); Akira Sato, Kanagawa (JP)

Correspondence Address: Jay H Maioli, Cooper & Dunham LLP, 1185 Avenue of the Americas, New York, NY, 10036, US

(21) Appl. No.: 09/783,806

(22) Filed: Feb. 15, 2001

(30) Foreign Application Priority Data
Feb. 21, 2000 (JP) P2000-048967

(51) Int. Cl. H04M 1/00

(52) U.S. Cl. 455/558; 455/557

(57) ABSTRACT

A wireless communications device capable of high quality radio communication. The present invention includes an antenna in which one surface of a grounding conductor and a planar radiating conductor are arranged approximately in parallel, a circuit board containing a wireless communications circuit that conducts radio communication via the antenna, and insertion means which holds the antenna and circuit board and which is inserted into an electronic device with the antenna sticking out. Therefore, when the present invention is inserted in the electronic device, current flowing through the radiating conductor generates an electric field between the grounding conductor and the radiating conductor in the direction from the grounding conductor to the radiating conductor to operate the radiating conductor almost alone as an antenna almost without operating the grounding conductor as an antenna. This makes it possible to prevent degradation of antenna characteristics and thus provides high quality radio communication.

### BACKGROUND OF THE INVENTION

1. Field of the Invention

The present invention relates to a wireless communications device, and more particularly, is suitably applied, for example, to a wireless communications device (hereinafter referred to as a wireless PC communications card) comprising a Personal Computer (PC) card compliant with the Personal Computer Memory Card International Association (PCMCIA) standard.

2. Description of the Related Art

Conventionally, this type of wireless PC communications card is used, for example, to build a plurality of notebook personal computer-based wireless Local Area Network (LAN) by being inserted detachably into a PC card slot in notebook personal computer (hereinafter referred to simply as a personal computer) to conduct radio communication with wireless PC communications cards inserted in other personal computers.

As shown in FIG. 1, this type of wireless PC communications card 1 comprises an approximately L-shaped card case 2 containing a circuit board (not shown) with a communications portion; and a connector (not shown) installed at an end face 2AX of a flat rectangular insertion part 2A of the card case 2 and equipped with a plurality of signal pins connected electrically to the circuit board.

An antenna housing 2B that is thicker than the insertion part 2A of the card case 2 is provided with an antenna housing groove 2BX, in which an antenna part 3 with a designated antenna element (not shown) electrically connected to the circuit board is mounted in such a way as to freely pivot centering around one end 3A in such a direction as to be retracted into the antenna housing 2B and housed in the antenna housing groove 2BX, and on the contrary in such a direction as to be raised up from the antenna housing groove 2BX against the antenna housing 2B.

Thereby, the wireless PC communications card 1 can raise up the antenna part 3 during communication to secure the required antenna characteristics and retract the antenna part 3 into the antenna housing groove 2BX when not in use to protect it from damage caused, for example, by an inadvertent hit by a hand.

Actually, with the insertion part 2A plugged into the PC card slot of a personal computer (not shown), the wireless PC communications card 1 takes sent data-from the personal computer into the circuit board via the connector, performs required transmission processing on it using the circuit board, and sends it to other wireless PC communications cards 1 via the antenna part 3.

The wireless PC communications card 1 takes the receive data sent by another wireless PC communications card 1, into the circuit board via the antenna part 3, performs required reception processing on it, and sends it out to the personal computer via the connector.

In this way, the wireless PC communications card 1 is designed to send and receive data to and from other wireless communications cards 1.

However, the wireless PC communications card 1 with such a configuration makes the antenna part 3 inconvenient to operate because the antenna part 3 is contained in the housing groove 2BX when not in use and it is raised up from the housing groove 2BX when used for communication.

Consequently, some wireless PC communications cards of this type are configured as shown in FIG. 2.

A wireless PC communications card 5 (FIG. 2) with such a configuration has an insertion part 6A and antenna housing 6B of the same thickness integrated into a single-piece flat rectangular card case 6, which contains a circuit board 7 with a communications portion.

A connector (not shown) equipped with a plurality of signal pins connected electrically to the circuit board is installed at the end face 6AX on the insertion part 6A side of the card case 6.

An antenna element 8 comprising meandering conductive foil is formed in a designated part of the circuit board 7 facing the antenna housing 6B. A transmitting and receiving circuit (not shown) and grounding conductor (not shown) connected to it are installed in a designated part of the circuit board 7 facing the insertion part 6A. And the antenna element 8 is electrically connected to the transmitting and receiving circuit.

Thereby, since the antenna element 8 is formed on the circuit board 7, the wireless PC communications card 5 can eliminate the inconvenience in the operation of the antenna part 3 encountered by the wireless PC communications card 1 described above with reference to FIG. 1.

In the wireless PC communications card 5, the grounding conductor (hereinafter referred to as a card-side grounding conductor) on the circuit board 7 is regarded as an antenna element and operated as a dipole antenna in conjunction with the antenna element 8.

As shown in FIG. 3, when the insertion part of the wireless PC communications card 5 is plugged into the PC card slot 9A of the personal computer 9, the card-side grounding conductor is electrically connected to a grounding conductor (not shown; hereinafter referred to as a PC-side grounding conductor) in the personal computer 9. Consequently, the antenna element 8 located outside the personal computer 9 and the card-side and PC-side grounding conductors located in the personal computer 9 (hereinafter referred to collectively as the compound grounding conductor) operate as a dipole antenna.

However, when the wireless PC communications card 5 is inserted into the personal computer 9, the compound grounding conductor comes close to a certain metal member in the personal computer 9, degrading antenna characteristics and thus impairing the quality of radio communication.

Also, in the wireless PC communications card 5, the compound grounding conductor becomes exceptionally large in comparison to the antenna element 8 reducing the current flowing through the antenna element 8 and thus making it difficult to emit radio waves. This degrades antenna characteristics and further impairs the quality of radio communication.

### SUMMARY OF THE INVENTION

In view of the foregoing, an object of this invention is to provide a wireless communications device capable of high quality radio communication.

The foregoing object and other objects of the invention have been achieved by the provision of a wireless communications device. An antenna in which one surface of a grounding conductor and a planar radiating conductor are arranged approximately in parallel, and a circuit board containing a wireless communications circuit that conducts radio communication via the antenna, are held by insertion means, and the insertion means is inserted into an electronic device by sticking out the antenna.

Thus, when the present invention is applied by being inserted in the electronic device, current flowing through the radiating conductor generates an electric field between the grounding conductor and the radiating conductor in the direction from the grounding conductor to the radiating conductor to operate the radiating conductor almost alone as an antenna almost without operating the grounding conductor as an antenna. This makes it possible to prevent degradation of antenna characteristics.

By grounding the radiating conductor to the grounding conductor near the side where the insertion means is inserted into the electronic device, the open end of the radiating conductor, which is located farthest from the ground location and emits radio waves most intensely, can be kept away from the electronic device to reduce degradation of the antenna characteristics substantially.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic perspective view showing the configuration of a conventional wireless PC communications card;

FIG. 2 is a schematic perspective view showing the configuration of another conventional wireless PC communications card;

FIG. 3 is a schematic perspective view illustrating the wireless PC communications card inserted in a personal computer;

FIG. 4 is a schematic perspective view showing a first embodiment of a general configuration of a wireless PC communications card according to the present invention;

FIG. 5 is a schematic perspective view showing an internal configuration of the wireless PC communications card;

FIG. 6 is a schematic plan view showing a configuration of an inverted-F type flat-plate antenna;

FIG. 7 is a schematic perspective view illustrating a layout of the inverted-F type flat-plate antenna;

FIG. 8 is a schematic top view illustrating an operation of the inverted-F type flat-plate antenna;

FIG. 9 is a schematic perspective view illustrating a wireless PC communications card inserted in a personal computer;

FIG. 10 is a schematic conceptual diagram illustrating a field intensity in the inverted-F type flat-plate antenna;

FIG. 11 is a schematic perspective view showing a configuration of the wireless PC communications card according to a second embodiment;

FIG. 12 is a schematic perspective view illustrating the layout of first and second inverted-F type flat-plate antennas;

FIGS. 13A to 13C are characteristic curves showing horizontal radiant gains of the wireless PC communications card;

FIG. 14 is a schematic perspective view illustrating a layout of the inverted-F type flat-plate antenna according to another embodiment;

FIG. 15 is a schematic perspective view illustrating a layout of the inverted-F type flat-plate antenna according to another embodiment; and

FIG. 16 is a schematic perspective view illustrating a layout of the inverted-F type flat-plate antenna according to another embodiment.

### DETAILED DESCRIPTION OF THE EMBODIMENT

Preferred embodiments of this invention will be described with reference to the accompanying drawings:

(1) First Embodiment

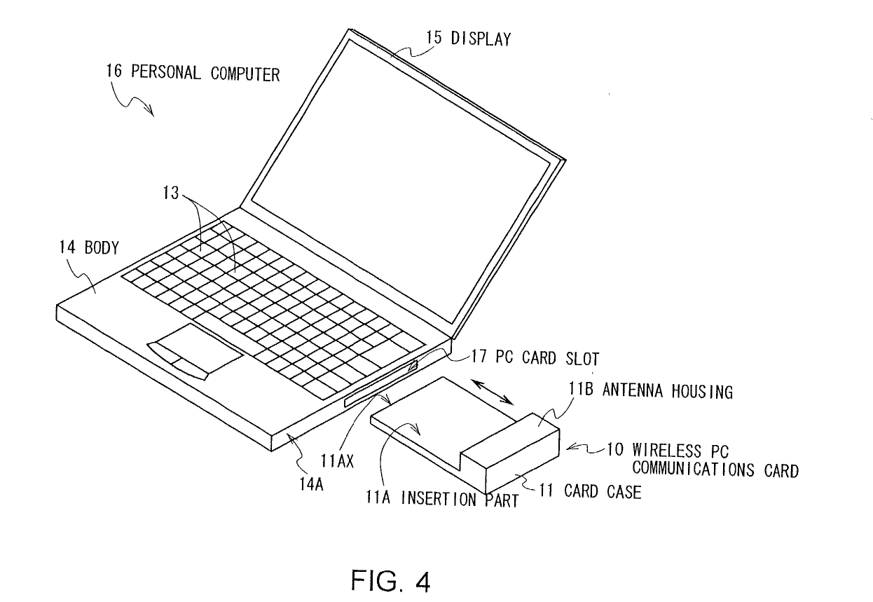

Referring to FIG. 4, reference numeral 10 denotes a wireless PC communications card according to a first embodiment, which comprises an approximately L-shaped single-piece card case 11 comprising a flat rectangular insertion part 11A and an antenna housing part 11B thicker than the insertion part 11A and containing a circuit board described later; and a connector (not shown) installed at the end face 11AX of the insertion part 11A and equipped with a plurality of signal pins connected electrically to the circuit board.

The wireless PC communications card 10 has been designed such that its insertion part 11A can be inserted into a PC card slot 17 provided in a side face 14A of the body 14 of a personal computer 16 which comprises the body 14 equipped with control keys 13 and a display 15 attached to the body such that it can be opened and closed freely. Thus, the wireless PC communications card 10 can be inserted detachably into the personal computer 16 with the antenna housing 11B sticking out.

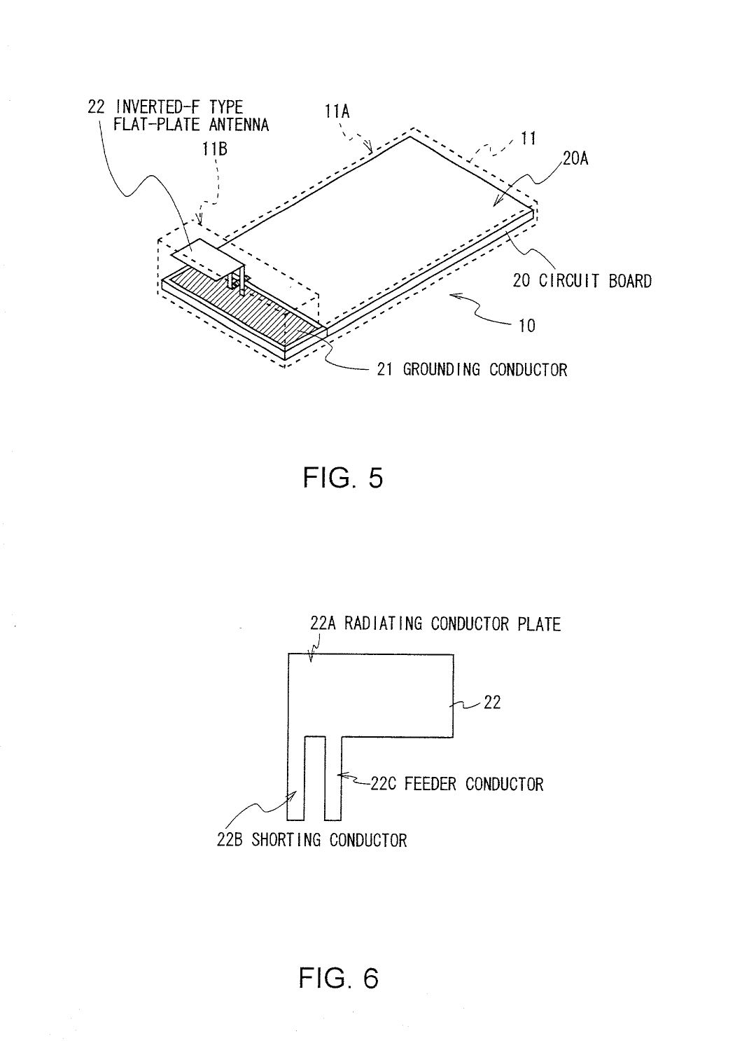

Actually, as shown in FIG. 5, the wireless PC communications card 10 contains the circuit board 20 in the card case 11.

A digital signal processing circuit and a transmitting and receiving circuit which compose a wireless communications portion (not shown) are installed in sequence on the insertion side of the circuit board 20, at the position where the circuit board 20 is inserted into the personal computer 16 facing the insertion part 11A, extending from the end face 11AX of the insertion part 11A to the antenna housing side facing the antenna housing part 11B.

Also, a planar card-side grounding conductor 21 and an inverted-F type flat-plate antenna 22 are installed on the antenna housing side on one surface 20A of the circuit board 20.

Here, as shown in FIG. 6, the inverted-F type flat-plate antenna 22 consists of a narrow band-shaped shorting conductor 22B and narrow band-shaped feeder conductor 22C installed on a designated side of a rectangular radiating conductor plate 22A forming an inverted F, all of which are made in one piece from a metal plate.

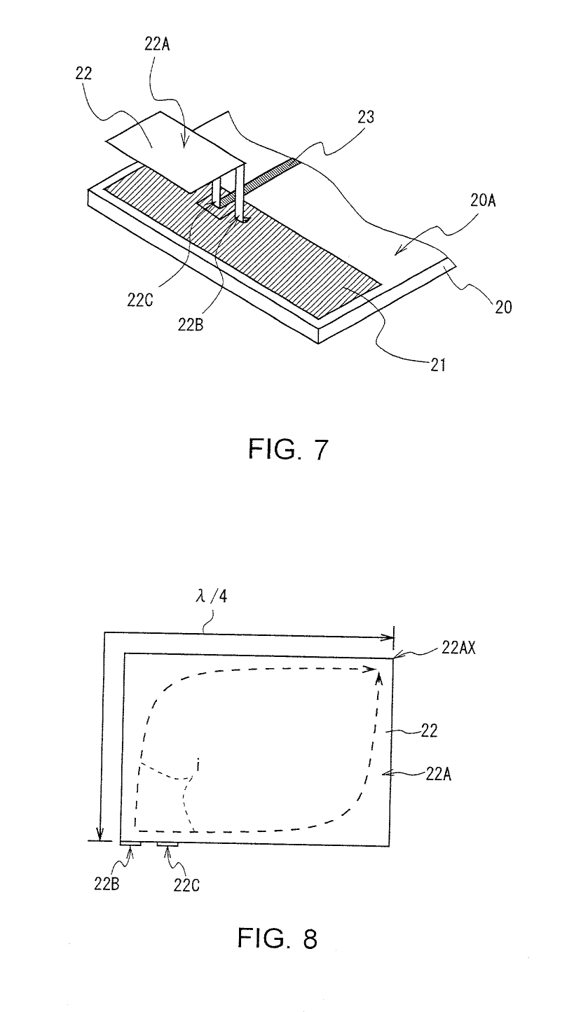

As shown in FIG. 7, in the inverted-F type flat-plate antenna 22, the shorting conductor 22B and feeder conductor 22C are bent in the same direction at an angle of approximately 90 degrees to the radiating conductor plate 22A, the radiating conductor plate 22A and card-side grounding conductor 21 are arranged approximately in parallel at a designated interval, and the shorting conductor 22B is grounded to the card-side grounding conductor 21 near the insertion side of the personal computer 16.

On one surface 20A of the circuit board 20, a feed line 23 made of a conductive pattern is formed on the boundary between the insertion side of the personal computer 16 and antenna housing side, being isolated-electrically from the card-side grounding conductor 21, and is connected to the transmitting and receiving circuit (not shown).

The feeder conductor 22C of the inverted-F type flat-plate antenna 22 is connected electrically and mechanically to the feed line 23 near the insertion side of the personal computer 16 and thereby connected electrically to the transmitting and receiving circuit via the feed line 23.

Thus, when the wireless PC communications card 10 is inserted into the personal computer 16, it takes sent data from an internal circuit board of the personal computer 16 into the digital signal processing circuit via the connector, performs required signal processing on it using the signal processing circuit, and sends it to other wireless PC communications cards 10 via the transmitting and receiving circuit and the inverted-F type flat-plate antenna 22 in sequence.

When receive data is sent by a remote wireless PC communications card 10, the local wireless PC communications card 10 receives it by the transmitting and receiving circuit via the inverted-F type flat-plate antenna 22, sends it out to the digital signal processing circuit to perform required signal processing on it, and sends out the resulting data to the internal circuit board of the personal computer 16 via the connector.

In this way, the wireless PC communications card 10 has been designed to send and receive data to and from other wireless PC communications cards 10.

In the inverted-F type flat-plate antenna 22, the radiating conductor plate 22A and card-side grounding conductor 21 are arranged approximately in parallel and electrically connected via the shorting conductor 22B, as described above with reference to FIG. 7.

Consequently, in the inverted-F type flat-plate antenna 22, when power is supplied during operation, for example, from the transmitting and receiving circuit to the radiating conductor plate 22A via the feeder conductor 22C and current i flows from the shorting conductor 22B to the point farthest from it, i.e., to the open end 22AX of the radiating conductor plate 22A, as 'shown in FIG. 8, an electric field directed from the card-side grounding conductor 21 to the radiating conductor plate 22A is generated between the radiating conductor plate 22A and a designated part of the card-side grounding conductor 21 facing it.

Therefore, the wireless PC communications card 10 has been designed to operate the inverted-F type flat-plate antenna 22 almost alone as an antenna by emitting radio waves from the radiating conductor plate 22A of the inverted-F type flat-plate antenna 22 according to the intensity and direction of the electric field generated between the inverted-F type flat-plate antenna 22 and card-side grounding conductor 21 almost without operating the grounding conductor 21 as an antenna.

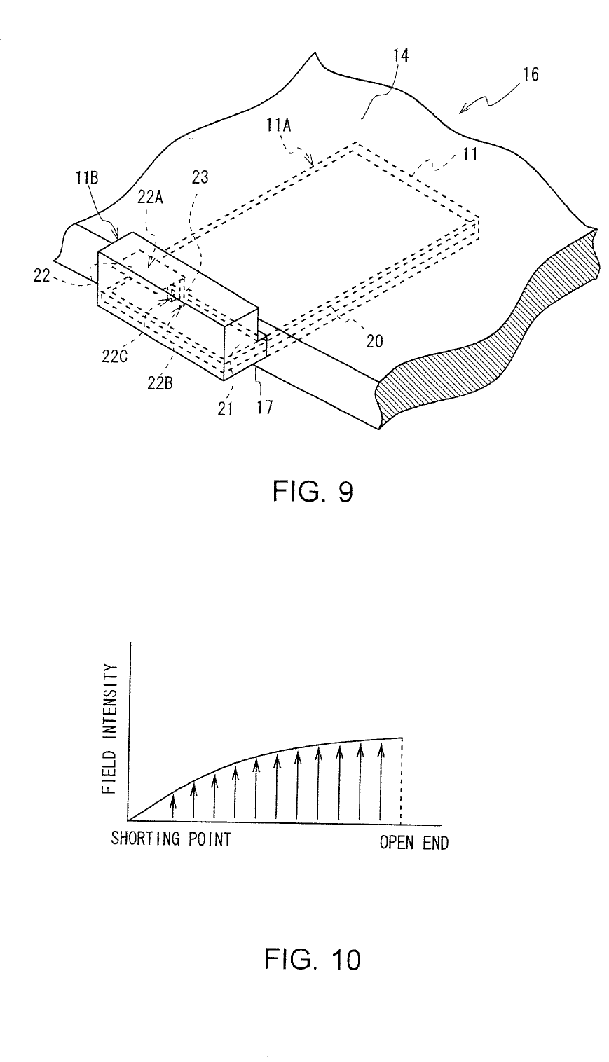

Thus, when the wireless PC communications card 10 is inserted into the personal computer 16 as shown in FIG. 9, connecting the card-side grounding conductor 21 to the PC-side grounding conductor (not shown) in the personal computer 16, the compound grounding conductor comprising the card-side grounding conductor 21 and PC-side grounding conductor almost does not operate as an antenna. Consequently, even if a given metal member in the personal computer 16 comes close to the compound grounding conductor, degradation of antenna characteristics is prevented during transmission and reception.

Also, since the wireless PC communications card 10 almost does not operate the compound grounding conductor as an antenna at this time, it can prevent reduction in the current flowing through the inverted-F type flat-plate antenna 22, which could otherwise make it difficult to emit radio waves. Thus, degradation of antenna characteristics is further reduced reliably.

In the inverted-F type flat-plate antenna 22 (FIG. 8), if the wavelength of the frequency to be used for transmission and reception of data according to the size of the radiating conductor plate 22A is denoted as λ, the electrical length of two adjacent sides of the rectangular radiating conductor plate 22A is λ/4.

Therefore, as shown by the field intensity characteristic curve D of FIG. 10, an electric field is actually generated between the inverted-F type flat-plate antenna 22 and card-side grounding conductor 21 such that the field intensity increases quadratically from the shorting point to the open end 22AX, reaching its minimum (for example, to zero) at the shorting point where the shorting conductor 22B is grounded to the card-side grounding conductor 21 and reaching its maximum at the open end 22AX of the radiating conductor plate 22A.

Thus, the inverted-F type flat-plate antenna 22 increases emitted radio waves quadratically from the shorting point to the open end 22AX according to the field intensity, emitting radio waves most intensely from the open end 22AX and emitting almost no radio waves from the shorting point.

Since the shorting conductor 22B of the inverted-F type flat-plate antenna 22 is grounded to the card-side grounding conductor 21 near the insertion side as described above with reference to FIG. 7, when the wireless PC communications card 10 is inserted into the personal computer 16 (FIG. 9), the shorting conductor 22B which emits almost no radio waves is located on the side nearest to the personal computer 16 and the open end 22AX of the radiating conductor plate 22A which emits radio waves most intensely is located away from the personal computer 16.

This allows the wireless PC communications card 10 to effectively restrain the personal computer 16 from acting as a shield against the inverted-F type flat-plate antenna 22, depending on the layout of the inverted-F type flat-plate antenna 22. Thus, degradation of antenna characteristics is reduced substantially during transmission and reception even when the wireless PC communications card 10 is inserted in the personal computer 16.

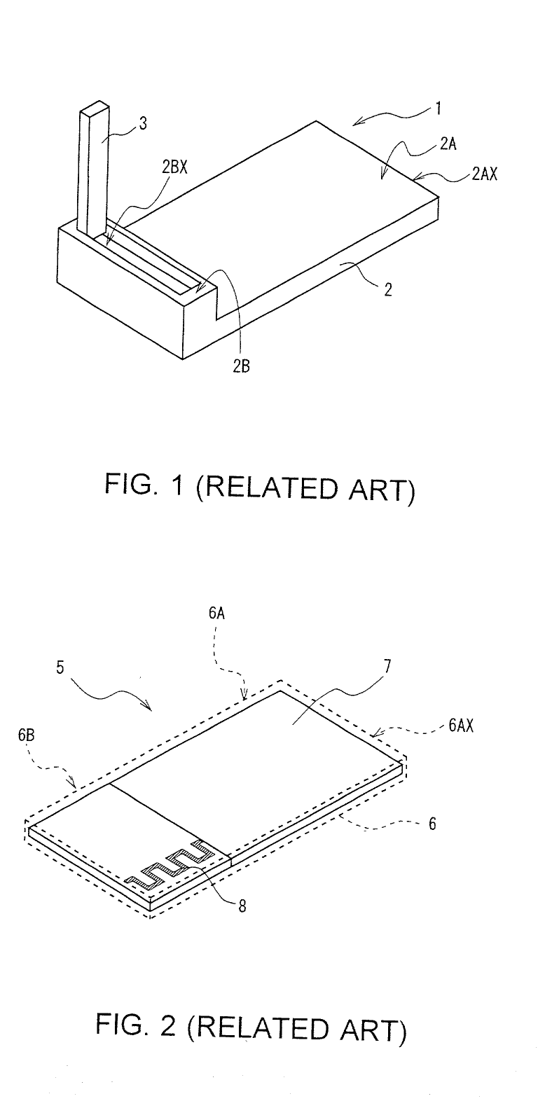

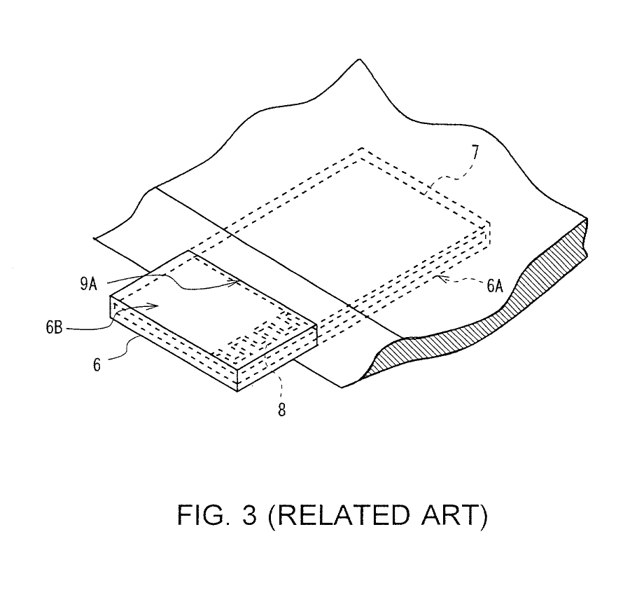

Incidentally, in the wireless PC communications card 10, the inverted-F type flat-plate antenna 22 is fixed to the circuit board 20 in the card case 11 to eliminate the inconvenience in the operation of the antenna part 3 encountered by the wireless PC communications card 1 described above with reference to FIG. 1.

Besides, in the wireless PC communications card 10, the feeder conductor 22C of the inverted-F type flat-plate antenna 22 is connected electrically and mechanically to the feed line 23 on the circuit board 20 near the insertion side of the personal computer 16, as is the case with the shorting conductor 2B, while the transmitting and receiving circuit is installed on the circuit board 20 near the antenna housing side. This makes it possible to shorten the feed line 23 which connects the feeder conductor 22C and the transmitting and receiving circuit, substantially reducing data transmission loss on the feed line 23.

In the case of the conventional wireless PC communications card 1 described above with reference to FIG. 1, since the antenna housing 2B of the card case 2 contains an end of the circuit board as well as the antenna part 3 extension/retraction mechanism and the antenna housing groove 2BX, the antenna housing 2B is enlarged in the thickness direction and longitudinal direction of the card case 2.

Also, in the case of the other conventional wireless PC communications card 5 described above with reference to FIG. 2, since the antenna element 8 is formed on the circuit board 7 with its longer dimension almost in parallel to the longer dimension of the card case 6, the antenna housing 6B is enlarged in the longitudinal direction of the card case 6.

Therefore, when these conventional wireless PC communications cards 1 and 5 are inserted in personal computers, the antenna housings 2B and 6B sticking out of the personal computers impair the operability and portability of the personal computers.

On the other hand, in the case of the wireless PC communications card 10 (FIG. 5) according to the first embodiment of the present invention, since the electrical length of two adjacent sides of the radiating conductor plate 22A is λ/4, it is possible to employ the inverted-F type flat-plate antenna 22 which can be downsized by reducing the width of the radiating conductor plate 22A and place it in such a way that the longer dimension of the radiating conductor plate 22A will be in parallel to the width of the card case 11. As a result, the shorter dimension of the antenna housing 11B can be made much smaller than in the case of the conventional wireless PC communications cards 1 and 5.

Also, in the case of the wireless PC communications card 10, since the gap between the inverted-F type flat-plate antenna 22 and the card-side grounding conductor 21, which is selected according to a desired bandwidth, is far smaller than the height required for the antenna part 3 extension/retraction mechanism and antenna housing groove 2BX of the conventional wireless PC communications card 1, the size of the antenna housing 11B can also be reduced along the thickness of the card case 11.

Therefore, when the wireless PC communications card 10 is inserted in the personal computer 16, the antenna housing 11B sticking out of the personal computer does not impair the operability and portability of the personal computer.

In the above configuration of the wireless PC communications card 10, the card-side grounding conductor 21 is installed on the antenna housing side of the circuit board 20 housed in the card case 11 and the inverted-F type flat-plate antenna 22 is placed such that the radiating conductor plate 22A and card-side grounding conductor 21 will be approximately parallel to each other.

Therefore, when the wireless PC communications card 10 is in operation, being inserted in the personal computer 16, current flowing through the radiating conductor plate 22A of the inverted-F type flat-plate antenna 22 generates an electric field between the card-side grounding conductor 21 and the radiating conductor plate 22A in the direction from the card-side grounding conductor 21 to the radiating conductor plate 22A to emit radio waves.

Consequently, the wireless PC communications card 10 can operate the inverted-F type flat-plate antenna 22 almost alone as an antenna almost without operating the card-side grounding conductor 21 (and the PC-side grounding conductor connected to it electrically) as an antenna and can thereby prevent degradation of the antenna characteristics of the inverted-F type flat-plate antenna 22 even if a metal member comes close to the card-side grounding conductor 21 in the personal computer 16 or the card-side grounding conductor 21 is electrically connected to the PC-side grounding conductor, making the conductive area far greater than that of the inverted-F type flat-plate antenna 22.

Besides, in the wireless PC communications card 10, since the shorting conductor 22B of the inverted-F type flat-plate antenna 22 is grounded to the card-side grounding conductor 21 on the circuit board 20 near the insertion side of the personal computer 16, the open end 22AX of the radiating conductor plate 22A, which is located farthest from the shorting conductor 22B and emits radio waves most intensely, can be kept away from the insertion side. This makes it possible to substantially reduce degradation of the antenna characteristics caused by the metal member in the personal computer 16 acting as a shield during operation.

According to the above configuration, the card-side grounding conductor 21 is installed on the antenna housing side of the circuit board 20 adjacent to the insertion side of the personal computer 16 and the inverted-F type flat-plate antenna 22 is placed such that the radiating conductor plate 22A and card-side grounding conductor 21 will be approximately parallel to each other. This makes it possible to operate the inverted-F type flat-plate antenna 22 almost alone as an antenna almost without operating the card-side grounding conductor 21 as an antenna and can thereby prevent degradation of the antenna characteristics by using the inverted-F type flat-plate antenna 20 at the time of being inserted in the personal computer 16. Thus, the present invention can implement a wireless PC communications card that provides high quality radio communication.

Besides, since the shorting conductor 22B of the inverted-F type flat-plate antenna 22 is grounded to the card-side grounding conductor 21 on the circuit board 20 near the insertion side of the personal computer 16, the open end 22AX of the radiating conductor plate 22A, which is located farthest from the shorting conductor 22B and emits radio waves most intensely, can be kept away from the insertion side of the personal computer 16. This makes it possible to substantially reduce degradation of the antenna characteristics caused by the metal member in the personal computer 16 and thus substantially reduce degradation in the quality of radio communication.

(2) Second Embodiment

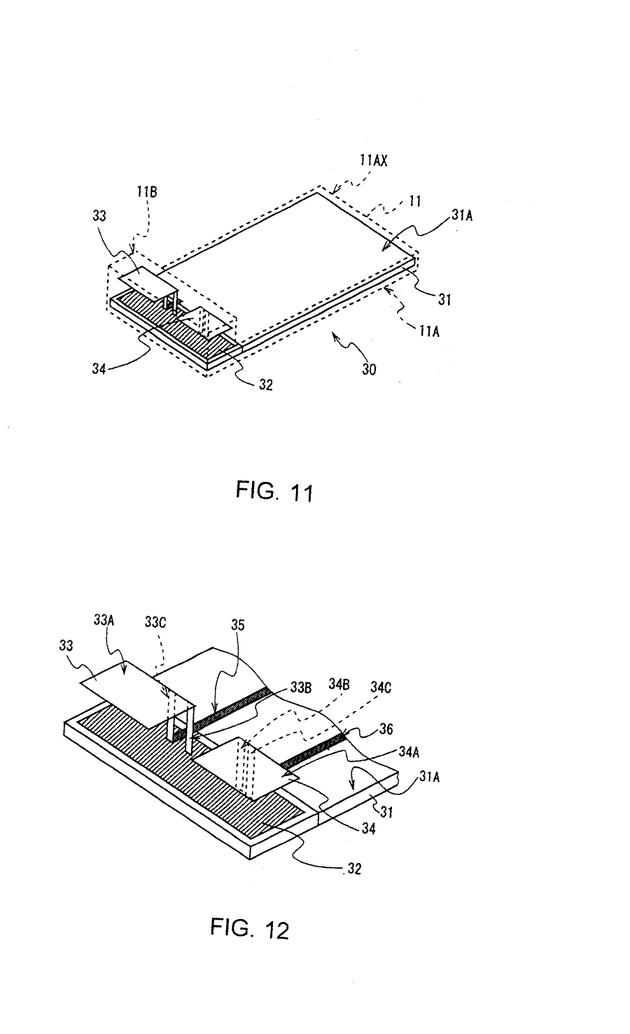

FIG. 11, where the parts corresponding to those in FIG. 5 are denoted by the same reference numerals, shows a wireless PC communications card 30 according to a second embodiment. The card case 11 contains a circuit board 31 and a connector (not shown) is installed at the end face 11AX of the insertion part 11A and equipped with a plurality of signal pins connected electrically to the circuit board.

On the circuit board 31, a digital signal processing circuit and a transmitting and receiving circuit which compose a wireless communications portion (not shown) and the latter of which is capable of performing required synthesis for space diversity reception, are installed in sequence on the insertion side of the personal computer (not shown), extending from the end face 11AX of the insertion part 11A to the antenna housing side.

On one surface 31A of the circuit board 31 a planar card-side grounding conductor 32 is installed on the antenna housing side. Also, first and second inverted-F type flat-plate antennas 33 and 34 are installed at a designated interval across the width of the card case 11.

As shown in FIG. 12, the first inverted-F type flat-plate antenna 33 is configured in a manner similar to the inverted-F type flat-plate antenna 22 (FIG. 5) according to the first embodiment: a radiating conductor plate 33A and card-side grounding conductor 32 are arranged approximately in parallel at a designated interval, a shorting conductor 33B is grounded to the card-side grounding conductor 32 on the insertion side of the personal computer, and a feeder conductor 33C is electrically connected to a first feed line 35 isolated electrically from the card-side grounding conductor 32.

The second inverted-F type flat-plate antenna 34 is placed symmetrically to the first inverted-F type flat-plate antenna 33 across the width of the card case 11: a radiating conductor plate 34A and the card-side grounding conductor 32 are arranged approximately in parallel at a designated interval, a shorting conductor 34B is grounded to the card-side grounding conductor 32 on the insertion side of the personal computer, and a feeder conductor 34C is electrically connected to a second feed line 36 formed being isolated electrically from the card-side grounding conductor 32.

On the insertion side of the personal computer of the circuit board 31, the first and second feed lines 35 and 36 are electrically connected to a transmitting and receiving circuit near the antenna housing side.

Thereby, in the wireless PC communications card 30, when receive data is sent by other wireless PC communications card, the receive data is received by the transmitting and receiving circuit via both of the first and second inverted-F type flat-plate antennas 33 and 34.

And, in the transmitting and receiving circuit, synthetic processing according to designated procedures such as a selective synthesis approach, equal gain synthesis approach, etc., is executed on received data obtained from the first and second inverted-F type flat-plate antennas 33 and 34.

And, by sending out the resulting synthetic data to the digital signal processing circuit, in the digital signal processing circuit, after performing required signal processing on the synthetic data, the synthetic data is sent out to the internal circuit board of the personal computer via the connector.

In this way, the wireless PC communications card 30 has been designed to receive, by means of space diversity reception, the receive data sent from other wireless PC communications cards.

Here, the wireless PC communication card 30 makes-both of the first and second inverted-F type flat-plate antenna 33 and 34 operate as antennas, however, by placing the first and second inverted-F type flat-plate antennas 33 and 34 at a sufficient distance from each other so that space diversity reception can be used, the wireless PC communications card 30 can operate each of them as an antenna during reception almost without operating the card-side grounding conductor 32 as an antenna. This prevents degradation of antenna characteristics.

Since the wireless PC communications card 30 has the shorting conductors 33B and 34B of the inverted-F type flat-plate antennas 33 and 34 grounded to the card-side grounding conductor 32 on the circuit board 31 near the insertion side of the personal computer, the open ends of the radiating conductor plates 33A and 34A, which emit radio waves most intensely, a re kept away from the personal computer. This makes it possible to substantially reduce degradation of the antenna characteristics.

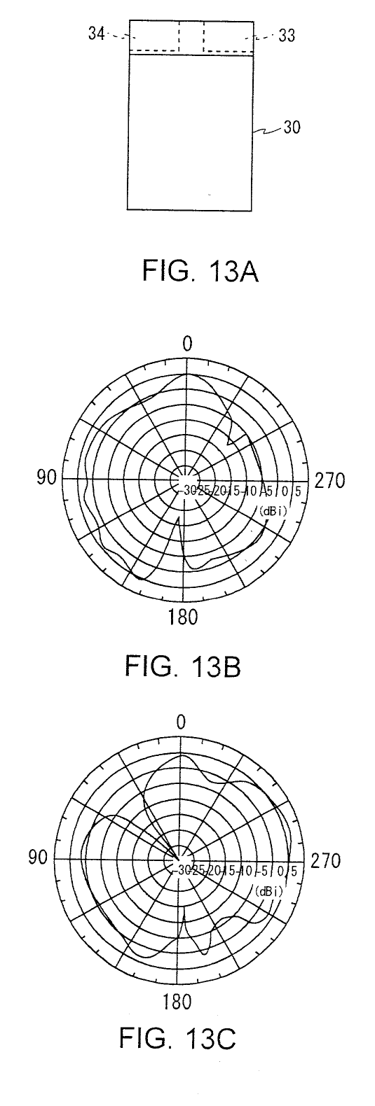

Incidentally, with the wireless PC communications card 30, as shown in FIGS. 13A to 13C, if along the length of the card case 11, the antenna housing side is taken as the front (the 0-degree positions in FIGS. 13B and 13C and the insertion side of the personal computer is taken as the rear (the 180-degree positions in FIGS. 13B and 13C), for example, the first inverted-F type flat-plate antenna 33 (FIG. 13A) shows radiation characteristics (FIG. 13B) with high radiant gains in the right rear corner and left front corner of a horizontally polarized wave and the second inverted-F type flat-plate antenna 34 (FIG. 13A) shows radiation characteristics (FIG. 13C) with high radiant gains in the left rear corner and right front corner of a horizontally polarized wave.

Thus, with the wireless PC communications card 30, generally the radiation characteristics of the first inverted-F type flat-plate antenna 33 and the radiation characteristics of the second inverted-F type flat-plate antenna 34 intersect and complement each other on the antenna housing side at the front. Consequently, when inserted in the personal computer, the wireless PC communications card 30 is designed to display such radiation characteristics that sensitivity of space diversity reception can increase on the antenna housing side at the front, i.e., outside the personal computer.

In the above configuration of the wireless PC communications card 30, the card-side grounding conductor 32 is installed on the antenna housing side of the circuit board 31 contained in the card case 11, the radiating conductor plates 33A and 34A of the first and second inverted-F type flat-plate antennas 33 and 34 are placed almost in parallel to the card-side grounding conductor 32 respectively, and the first and second inverted-F type flat-plate antennas 33 and 34 are placed keeping a designated distance between the radiating conductor plates 33A and 34A.

Therefore, the use of the first and second inverted-F type flat-plate antennas 33 and 34 allows the wireless PC communications card 30 inserted in the personal computer to operate each of them as an antenna almost without operating the card-side grounding conductor 32 (and the PC-side grounding conductor connected to it electrically) as an antenna. This allows good space diversity reception by preventing degradation of the antenna characteristics of the inverted-F type flat-plate antennas 33 and 34 even if metal members come close to the card-side grounding conductor 32 in the personal computer or the card-side grounding conductor 32 is electrically connected to the PC-side grounding conductor, making the conductive area far greater than that of the first and second inverted-F type flat-plate antennas 33 and 34.

Also, since the wireless PC communications card 30 has the shorting conductors 33B and 34B of the first and second inverted-F type flat-plate antennas 33 and 34 grounded to the card-side grounding conductor 32 on the circuit board 31 near the insertion side of the personal computer, it can keep the open ends of the radiating conductor plates 33A and 34A away from the personal computer and thus can reduce degradation of the antenna characteristics of the first and second inverted-F type flat-plate antennas 33 and 34 substantially. Therefore, even when the wireless PC communications card 30 is inserted in the personal computer, it can substantially reduce degradation in the sensitivity of space diversity reception and thus degradation in the quality of radio communication.

According to the above configuration, the card-side grounding conductor 32 is installed on the antenna housing side of the circuit board 31 adjacent to the insertion side of the personal computer and the first and second inverted-F type flat-plate antennas 33 and 34 are placed such that their radiating conductor plates 33A and 34A will be approximately parallel to the card-side grounding conductor 32 and will be kept at a designated distance from each other. In addition to the effects produced by the first embodiment described above, this configuration allows the wireless PC communications card 30 inserted in the personal computer to operate the first and second inverted-F type flat-plate antennas 33 and 34 as antennas almost without operating the card-side grounding conductor 32 as an antenna. This allows good space diversity reception by preventing degradation of the antenna characteristics of the first and second inverted-F type flat-plate antennas 33 and 34. Thus, the present invention can implement a wireless PC communications card that provides high quality radio communication even during space diversity reception.

(3) Other embodiments

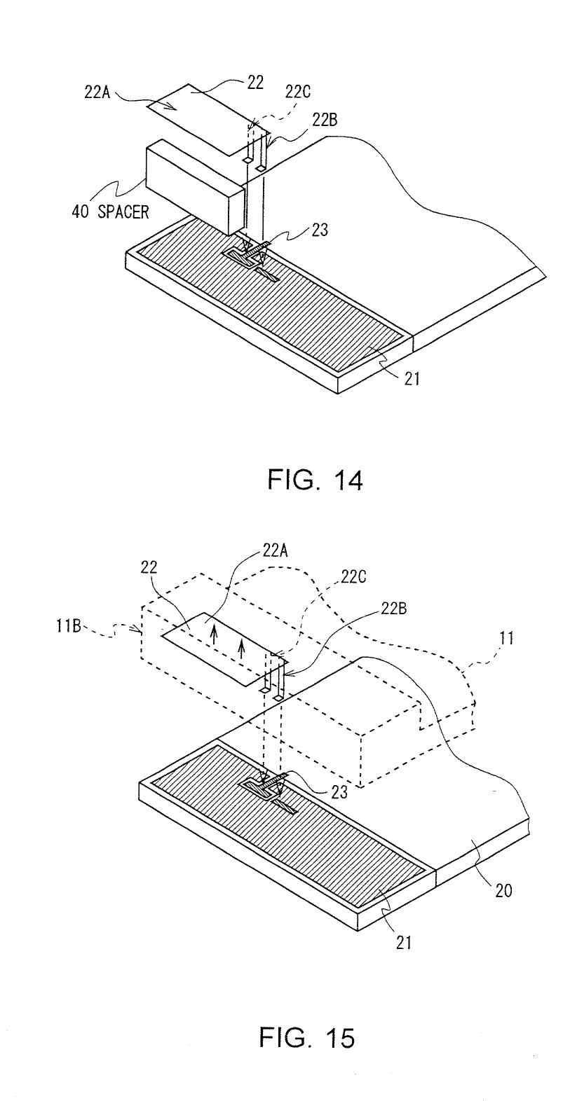

As apparent from FIGS. 7 and 12, in the first and second embodiments described above, the inverted-F type flat-plate antenna 22 or the first and second inverted-F type flat-plate antennas 33 and 34 are laid out on the circuit board 20 or 31 by simply bending the shorting conductor 22B or the shorting conductors 33B and 34B and the feeder conductor 22C or the feeder conductors 33C or 34C to the radiating conductor plate 22A or the radiating conductor plates 33A and 34A. However, the present invention is not limited to these configurations. It is also possible to lay out the inverted-F type flat-plate antenna 22 on the circuit board 20 with a cubic spacer 40 made of insulating material or dielectric material placed between the card-side grounding conductor 21 and radiating conductor plate 22A as shown in FIG. 14 with corresponding parts denoted by the same reference numerals as in FIG. 7 or to lay out the inverted-F type flat-plate antenna 22 by sticking the radiating conductor plate 22A to the inside surface of the top plate of the antenna housing 11B of the card case 11 as shown in FIG. 15 with corresponding parts denoted by the same reference numerals as in FIG. 7.

This allows the wireless PC communications card to maintain the arrangement and position of the inverted-F type flat-plate antenna 22, preventing changes in antenna characteristics, even if it is accidentally dropped or receives an external shock otherwise.

As described above with reference to FIG. 14, when placing the spacer 40 between the radiating conductor plate 22A of the inverted-F type flat-plate antenna 22 and the card-side grounding conductor 21, if the spacer 40 is made of dielectric material, the propagation velocity of the radio waves emitted from the radiating conductor plate 22A becomes slower in the spacer 40 than in free space, corresponding to the permittivity of the dielectric material. This shortens the wavelength, resulting in a so-called wavelength reduction effect, which makes it possible to downsize the radiating conductor plate 22A of the inverted-F type flat-plate antenna 22. Thus, the wireless PC communications card can be made smaller than the wireless PC communications cards 10 and 30 according to the first and second embodiments described above.

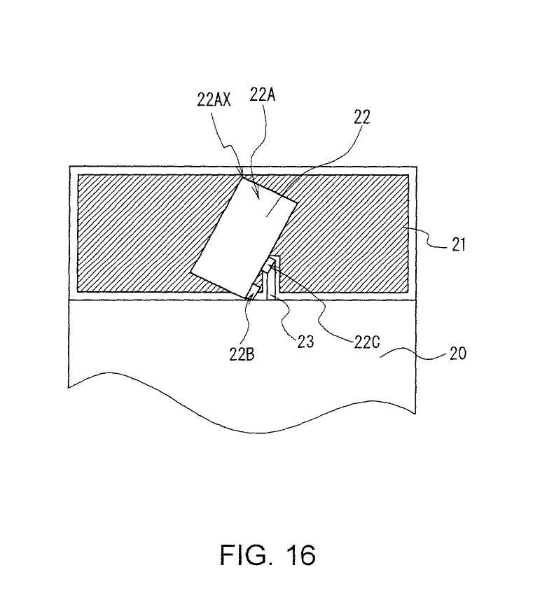

Also, although the first and second embodiments have been described above with reference to the case in which the inverted-F type flat-plate antenna 22 or the first and second inverted-F type flat-plate antennas 33 and 34 are laid out on the circuit board 20 or 31 such that the length of the radiating conductor plate 22A or the radiating conductor plates 33A and 34A will be approximately parallel to the width of the card case 11 as can be seen from FIGS. 5 and 11, the present invention is not limited to that. It is also possible to lay out the inverted-F type flat-plate antenna 22 on the circuit board 20 such that the diagonal of the radiating conductor plate 22A joining the shorting point and the open end 22AX of the radiating conductor plate 22A will be approximately parallel to the length of the card case 11 as shown in FIG. 16 with corresponding parts denoted by the same reference numerals as in FIG. 7.

This makes it possible to place the open end 22AX of the radiating conductor plate 22A farthest away from the personal computer with the shorting conductor 22B placed closest to the insertion side of the personal computer. Consequently, when this wireless PC communications card is inserted in the personal computer, degradation of antenna characteristics is reduced more greatly than the wireless PC communications cards 10 and 30 of the first and second embodiments described above.

Besides, although the first and second embodiments have been described above with reference to the case in which they use the inverted-F type flat-plate antenna 22 or the first and second inverted-F type flat-plate antennas 33 and 34 that consist of the radiating conductor plate 22A or the radiating conductor plates 33A and 34A, the shorting conductor 22B or the shorting conductors 33B and 34B, and the feeder conductor 22C or the feeder conductors 33C and 34C made in one piece from a conductive metal plate, the present invention is not limited to that. It is also possible to build the inverted-F type flat-plate antenna by forming the radiating conductor plates, shorting conductors, and feeder conductors in one piece from a polyimide or other resin film and coating the film with conductive metal leaf by plating, deposition, or any of various other methods. And such an inverted-F type flat-plate antenna will provides the same benefits as the first and second embodiments.

Furthermore, although the second embodiment has been described above with reference to the case in which the first and second inverted-F type flat-plate antennas 33 and 34 are placed on the circuit board 31 for space diversity reception, the present invention is not limited to that. It is also possible to place on the circuit board two or more inverted-F type flat-plate antennas that have radiating conductor plates approximately parallel to one or more card-side grounding conductors to allow space diversity reception, polarization diversity reception, and other types of diversity reception in the same or different frequency bands.

Also, although the first and second embodiments have been described above with reference to the case in which the present invention is applied to the wireless PC communications cards 10 and 30 compliant with the PCMCIA standard for building a wireless LAN as described above in relation to FIGS. 5 and 11, the present invention is not limited to that. It can be applied widely to wireless communications devices of various shapes such as card shape or stick shape and of various types including those that can communicate data via Personal Handy-phone System (PHS) as long as they can be inserted into various electronic devices such as personal computers.

Besides, although the first and second embodiments have been described above with reference to the case in which they use the card-side grounding conductor 21 or 32 and the inverted-F type flat-plate antenna 22 or the first and second inverted-F type flat-plate antennas 33 and 34 as antennas in which one surface of the grounding conductor is placed approximately in parallel to the radiating conductor plate, the present invention is not limited to that. It can use a wide variety of antennas, including a unilaterally short-circuited antenna in which one surface of the grounding conductor is placed approximately in parallel to a planar radiating conductor.

Furthermore, although the first and second embodiments have been described above with reference to the case in which the rectangular radiating conductor plate 22A or the rectangular radiating conductor plates 33A and 34A are used as the planar radiating conductor(s), the present invention is not limited to that. It can widely use radiating conductors of various appearances and patterns, including meandering radiating conductors as long as they are planar.

Also, although the first and second embodiments have been described above with reference to the case in which the circuit board 20 or 31 contained in the card case 11 from the insertion part 11A to the antenna housing 1B is used as the circuit board containing a wireless communications circuit that conducts radio communication via the antenna, the present invention is not limited to that. It can widely use circuit boards of various appearances and shapes as long as they have a wireless communications circuit for conducting radio communication via an antenna.

Besides, although the first and second embodiments have been described above with reference to the case in which the approximately L-shaped card case 11 is used as the insertion means that holds the circuit board and antenna and that is inserted into a designated electronic device with the antenna sticking out, the present invention is not limited to that. It can use insertion means of various other shapes and configurations as long as they hold the circuit and antenna and they can be inserted into a designated electronic device with the antenna sticking out.

Furthermore, although the first and second embodiments have been described above with reference to the case in which the personal computer 16 is used as the electronic device into which insertion means is inserted, the present invention is not limited to that. It can be applied to a wide variety of electronic devices including desktop personal computers and Personal Digital Assistance (PDA).

As described above, according to the present invention, an insertion means holds an antenna in which one surface of a grounding conductor and a planar radiating conductor are arranged approximately in parallel as well as a circuit board containing a wireless communications circuit that conducts radio communication via the antenna. Since the insertion means is inserted into an electronic device with the antenna sticking out, current flowing through the radiating conductor generates an electric field between the grounding conductor and the radiating conductor in the direction from the grounding conductor to the radiating conductor to operate the radiating conductor almost alone as an antenna almost without operating the grounding conductor as an antenna. This makes it possible to prevent degradation of antenna characteristics and thus provides high quality radio communication.

Besides, by grounding the radiating conductor to the grounding conductor near the side where the insertion means is inserted into the electronic device, the open end of the radiating conductor, which is located farthest from the ground location and emits radio waves most intensely, can be kept away from the electronic device to substantially reduce degradation of the antenna characteristics and thus degradation in the quality of radio communication as well.

While there has been described in connection with the preferred embodiments of the invention, it will be obvious to those skilled in the art that various changes and modifications may be aimed, therefore, to cover in the appended claims all such changes and modifications as fall within the true spirit and scope of the invention.

What is claimed is:

1. A wireless communications device comprising:
an antenna in which one surface of a grounding conductor and a planar radiating conductor are arranged approximately in parallel;
a circuit board containing a wireless communications circuit that conducts radio communication via said antenna; and
insertion means which holds said circuit board and said antenna and which is inserted into a designated electronic device with the antenna sticking out.

2. The wireless communications device according to claim 1 wherein said antenna has said radiating conductor grounded to said grounding conductor near the side where said insertion means is inserted into said electronic device.

3. The wireless communications device according to claim 1 wherein said antenna has one surface of one or more said grounding conductors and a plurality of said radiating conductors arranged approximately in parallel.
